(19) United States
(12) Patent Application Publication
(10) Pub. No.: US 2020/0287255 A1
(43) Pub. Date: Sep. 10, 2020

(54) METHOD FOR CONTROLLING THE TEMPERATURE OF A BATTERY ARRANGEMENT AND TEMPERATURE-CONTROLLED BATTERY ARRANGEMENT

(71) Applicant: FAHRENHEIT GMBH, München (DE)

(72) Inventors: Ralph Herrmann, Halle/Saale (DE); Walter Mittelbach, Freiburg i. Br. (DE); Charles Peurois, München (DE)

(21) Appl. No.: 16/763,973

(22) PCT Filed: Nov. 27, 2018
(86) PCT No.: PCT/EP2018/082641

§ 371 Date: May 13, 2020

(30) Foreign Application Priority Data
Nov. 28, 2017 (DE) 10 2017 128 152.5
Apr. 17, 2018 (DE) 10 2018 109 127.3

(51) Int. Cl. H01M 10/6552; H01M 10/659; H01M 10/663; H01M 10/625

(52) U.S. Cl. CPC H01M 10/6552; H01M 10/659; H01M 2220/20; H01M 10/625; H01M 10/663

(57) ABSTRACT

The invention relates to a method for controlling the temperature of a battery arrangement made up of at least one battery cell by means of a cyclically operated adsorption heat pump, consisting of an adsorber and a phase converter with a working medium circulated between the adsorber and the phase converter, wherein the at least one battery cell is brought into thermal contact with an adsorbent of the adsorber and the temperature of the battery cell is controlled in that the battery arrangement picks up adsorption heat and gives off desorption heat, wherein the heat released in the phase converter during a condensation process of the working medium and the heat picked up during an evaporation process of the working medium is dissipated to the environment and supplied from the latter. The method is characterized in that the battery arrangement and the adsorber are, if necessary, brought into thermal contact, via an auxiliary fluid circuit, with a heat transfer fluid circulated in the auxiliary fluid circuit, wherein the heat transfer fluid is brought into thermal contact with external heat sources and/or heat sinks, wherein the battery arrangement is supplied, if necessary, with thermal energy from external heat sources via the auxiliary fluid circuit or thermal energy is withdrawn from the battery arrangement via the auxiliary fluid circuit and dissipated to external heat sources.

The invention relates to a method for controlling the temperature of a battery arrangement and a temperature-controlled battery arrangement according to the preambles of claim 1, and to a temperature-controlled battery arrangement according to the preamble of claim 7.

Methods for controlling the temperature of a batterie arrangement are aimed at an optimal temperature setting of the battery while taking into consideration the respectively given operational states of the battery. Controlling the temperature of the battery arrangement is in particular necessary in battery arrangements of the higher power range so as to be able to charge the battery arrangements effectively and in a time as short as possible or else to make the battery arrangement ready for operation as quickly as possible. This is in particular the case in battery arrangements serving the purpose of supplying energy to drive motors of electric vehicles.

The battery arrangement of an electric vehicle especially requires a cooling for the protection of the battery which is active during charging and also while discharging the battery during driving. Particularly, during a quick charging of such battery arrangements by so-called super-chargers, i.e. special charging stations having relatively high charging currents, considerable heat amounts are released within the battery arrangement which need to be dissipated as uniformly as possible so as to prevent the cells in the battery pack from being overheated locally. At the same time, batteries employed in electric vehicles must be heated to a certain operational temperature even in the case of low outdoor temperatures so that their range will be maximized. When outdoor temperatures are low, a cold start of the battery will in particular lead to quick discharging, and this has a negative impact upon the lifetime of the battery.

Temperature controls of such battery arrangements can be performed by using the adsorption technology with so-called adsorption heat pumps. The battery cells are in this case in thermal contact with an adsorbent. They may in particular be coated with a solid adsorbent. The coating is made, for example, of zeolites crystallized upon an aluminum sheet or of a coating using organic or inorganic binding agents. This allows the surfaces of the individual battery cells in battery packs to be used as adsorbers for sorption processes having various adsorptives in negative pressure, for example, while using water vapor, or in positive pressure, for example, while using carbon dioxide. Thereby, uniform heat dissipation and heat supply are enabled by desorption and adsorption processes.

In the use of adsorption heat pumps according to the state of the art, the heat management and thus the temperature control of the batteries is implemented in the following manner:

The adsorber is in fluid-conducting connection with a heat exchanger used for the phase conversion of the adsorptive. This heat exchanger thus acts as a phase converter. A working medium is circulated between the adsorber and the phase converter via the connection. This circulation is performed via cyclical adsorptions and desorptions of the working medium at the adsorber. The phase converter is cooled or heated by an external cooling circuit or an external heat source preferably using the existing air conditioning system of the vehicle.

During the quick charging of the battery, the working medium, i.e. the adsorptive, is desorbed from the saturated adsorber due to the dissipated heat released in this case. The released adsorptive flows to the phase converter, where it is condensed. The condensation heat released in this case is dissipated by the external system, for example, the air conditioning system of the vehicle.

For heating the battery arrangement, the hereto inverse operation is performed. Due to the adsorption process, the adsorber aspirates the condensate contained within the phase converter. The working medium is adsorbed into the adsorber and releases heat during the adsorption. This heat is output to the cells of the battery via heat conduction. The necessary evaporation heat that needs to be supplied to the phase converter, is supplied to the phase converter at ambient temperature via an external system, e.g. the heat exchanger of the vehicle's air conditioning system.

Such a battery arrangement temperature control which is based on adsorption processes, however, has a series of disadvantages. A very important disadvantage is that a continuous cooling of the battery arrangement cannot be guaranteed by such an adsorptive temperature control method. This is due to the fact that in the described system of the state of the art, the sorbate load of the adsorber is in inverse correlation to the charging state of the battery. Since the working medium is expelled from the adsorber during recharging of the battery, with the battery then being cooled, the adsorber normally is unloaded once the battery has reached its maximum state of charge. A further desorption of the working medium is then no longer possible. If subsequently the battery is discharged again, the heat released during battery operation may no longer be dissipated from the battery via the adsorption heat pump. Moreover, the adsorber may no longer be reloaded with the working medium, since during the operation of the battery, a supply of adsorption heat to the battery cells is not necessary or even tends to be disadvantageous.

Moreover, the case occurs very often that during operation of the vehicle or in case of high outdoor temperatures, when no heating of the battery in the cold start is required, the storage discharge of the adsorber cannot be performed or only in a very difficult manner, since the released adsorption heat needs to be dissipated to the environment having a high ambient temperature. In this case, the battery arrangement can only poorly expel the working medium from the adsorber, its heat is dissipated and transferred to the environment only insufficiently, and the adsorption heat pump works very ineffectively or is inoperative.

Now, there is the task underlying the invention to remedy the mentioned difficulties and disadvantages.

The solution of the task is performed by a method for controlling the temperature of a battery arrangement having the features of claim 1, and a temperature-controlled battery arrangement having the features of claim 7. The dependent claims include appropriate or advantageous embodiments of the method and the temperature-controlled battery arrangement.

The method for controlling the temperature of a battery arrangement is based on a basic configuration, in which at least one battery cell is cyclically cooled or heated by means of a cyclically operated heat pump, consisting of an adsorber and a phase converter, with a working medium circulated between the adsorber and the phase converter. During this, the at least one battery cell is brought into thermal contact with an adsorbent of the adsorber and the temperature of the battery cell is controlled in that the latter picks up adsorption heat and gives off desorption heat. During this, the heat released in the phase converter during a condensation process of the working medium and the heat picked up during an evaporation process of the working medium is dissipated to the environment and supplied from the latter.

According to the invention, the method is distinguished in that the battery arrangement and the adsorber, as well as the phase converter are, if necessary, brought into thermal contact via an auxiliary fluid circuit, with a heat transferring fluid circulated in the auxiliary fluid circuit. During this, the heat transferring fluid is in thermal contact with external heat sources and/or heat sinks, wherein the battery arrangement is supplied, if necessary, with thermal energy from external heat sources via the auxiliary fluid circuit or thermal energy is withdrawn from the battery arrangement via the auxiliary fluid circuit and dissipated to external heat sinks.

In a first embodiment of the method, the auxiliary fluid circuit is in material separation from the adsorption heat pump. Via a heat exchange surface, the heat transferring fluid is conducted along the entire arrangement of the battery arrangement and the adsorber, and is different from the working medium of the adsorption heat pump.

In addition to the cyclic temperature control of the battery arrangement by the adsorption heat pump, the auxiliary fluid circuit enables the entire device of battery arrangement and adsorber to be temperature-controlled. This auxiliary fluid circuit especially becomes active, when the battery arrangement during normal operation is to be temperature-controlled, and enables a desired charging of the adsorber with the working medium to be regenerated during regular operation of the battery.

In a further embodiment of the invention, during the start-up of the auxiliary fluid circuit, the adsorption heat pump is temporarily shifted from cyclical operation to an operating mode of forced convection. During this, the working medium is introduced in excess into the adsorber, and the adsorber is flooded. Subsequently, the liquid working medium is circulated as the heat transferring fluid by forced convection without any phase change. Due to introducing the working medium in excess, desorption and adsorption processes will not take place, and the components of the adsorption heat pump will then effectively act only as parts of a heat carrier circuit, whereas the working medium of the adsorption heat pump merely functions as the heat transferring fluid without any phase conversions and adsorptions and desorptions.

In the present context, forced convection means that the working medium is neither aspired into the adsorber nor expelled from the adsorber by adsorption or desorption, rather the working medium is mechanically circulated, in particular by means of a pump, and transports heat in this case conventionally and by mere circulation.

In an implementation of the method, the switch-over between cyclical operation and operation of forced convection is performed by a controlled change of the system pressure within the adsorption heat pump. In this case, the change of the system pressure is performed depending on instantaneous operating parameters and/or operational states of the battery arrangement, in particular of charging and/or discharging powers of the battery arrangement and/or depending on current environmental conditions.

The switch-over between cyclical operation and operation of forced convection may in particular also be performed by supplying and discharging the working medium by means of a pump unit, wherein the control of the pump unit is performed depending on instantaneous operating parameters of the battery arrangement and/or current environmental conditions.

In this case, the working medium is in particular withdrawn from an existing reservoir and supplied through the pump unit. With a return to the cyclical operating mode, the working fluid is returned again into the reservoir and collected there, so that only the working medium adsorbed within the adsorber remains and is again available as the actually cyclical working medium.

In a further embodiment of the method, the auxiliary fluid circuit is formed as a heat pipe, wherein the heat transferring fluid makes a phase transition at the external heat source and/or the external heat sink and performs a corresponding heat exchange there with external heat sources of heat sinks. During this, attention should be paid to the fact that the heat transferring fluid does not perform any adsorptions or desorptions.

As far as the device is concerned, the temperature-controlled battery arrangement is composed of a plurality of battery cells and a battery cell temperature control unit integrated in the battery arrangement and surrounding each individual battery cell, wherein the battery cell temperature control unit may be coupled to external temperature control devices.

In one embodiment, the battery cell temperature control unit has an adsorbent section covering at least one first surface section of the battery cell and being in thermal contact with the battery cell for coupling to an adsorption heat pump, and a second, heat conducting section in thermal contact with the environment.

In one embodiment, the battery cell temperature control unit is comprised of a series of flow channels extending between the battery cells, wherein the flow channels are formed alternatingly as sorption flow channels filled with an adsorbent and loaded with an adsorbate, and as heat flow channels through which fluid can flow.

The battery cell temperature control unit may also be formed as an arrangement of a first, inner flow channel surrounding the battery cell in thermal contact and a second, outer flow channel surrounding the inner flow channel in thermal contact.

The inner and the outer flow channels are filled with an adsorbent, and the adsorbent can be loaded with an adsorbate, wherein the flow channel filled with the adsorbent is coupled to an adsorption heat pump, and the respective other flow channel is coupled to an external heat carrier circuit.

The battery cell temperature control unit may also be formed in the form of heat transfer plates through which a fluid flows and which are in thermal contact with a first surface section of the battery cell and a sorption channel loaded with an adsorbent, wherein the heat transfer plates are connected to an external heat carrier circuit and the sorption channel is part of an adsorption heat pump.

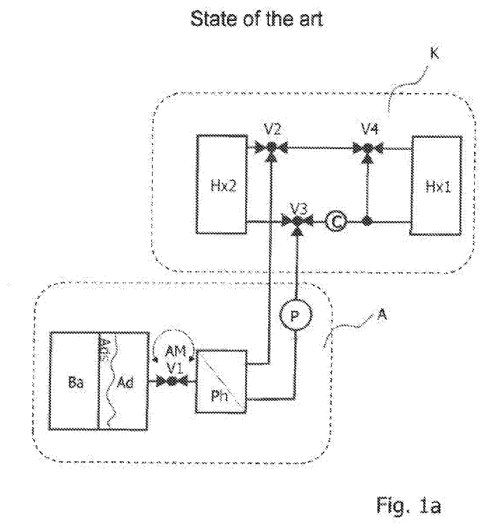

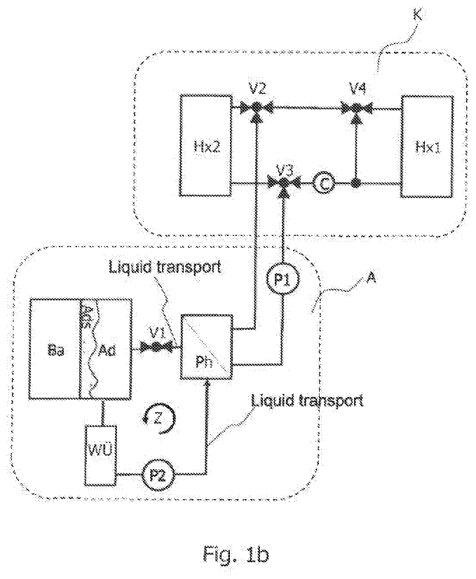

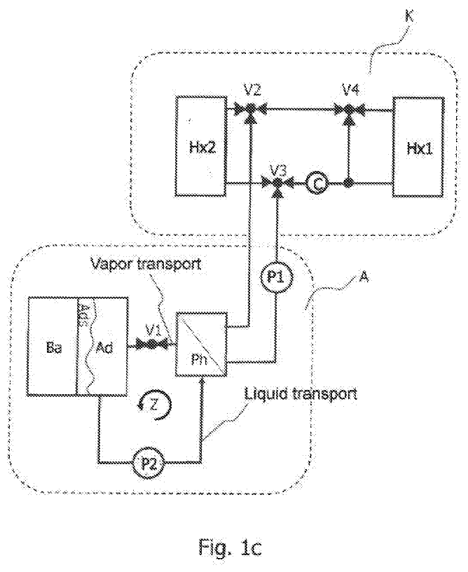

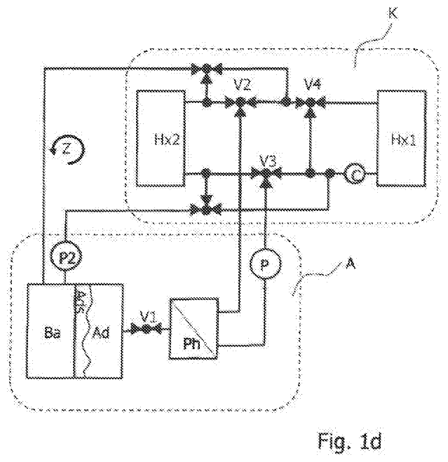

The method and the device for controlling the temperature of a battery arrangement and the temperature-controlled battery arrangement will be explained in more detail below based on exemplary embodiments. FIGS. 1a to 13 serve the purpose of clarification. Identical numerals will be used for identical parts or parts of identical action.

Shown are in:

FIG. 1a a principle representation of a battery temperature control with an adsorber and a phase converter according to the state of the art,

FIG. 1b a principle representation of the additional heat carrier circuit as a complementation of the cyclical operation of the adsorption heat pump,

FIG. 1c a principle representation of the additional heat carrier circuit using a heat pipe,

FIG. 1d a principle representation of a battery temperature control with an adsorber and a phase converter in a further realization according to the invention,

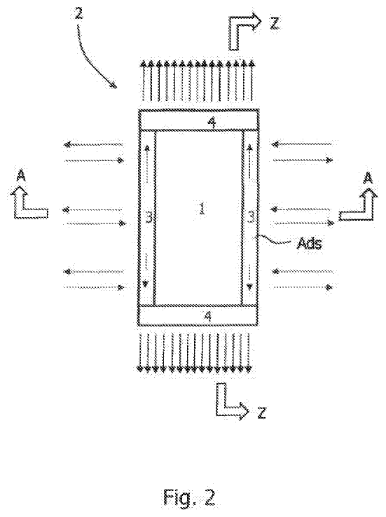

FIG. 2 a representation of the heat conduction processes within the structural material of the adsorber during the continuous operation of the battery arrangement,

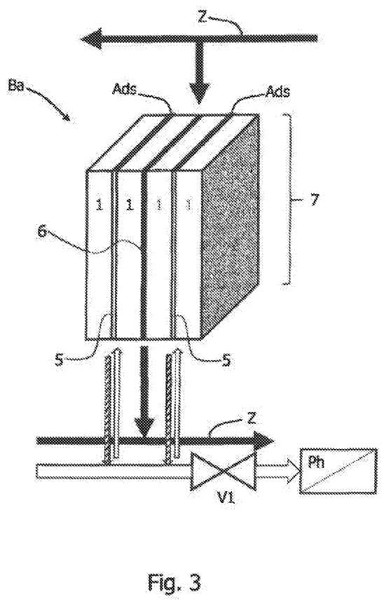

FIG. 3 a representation of a first embodiment of the battery arrangement,

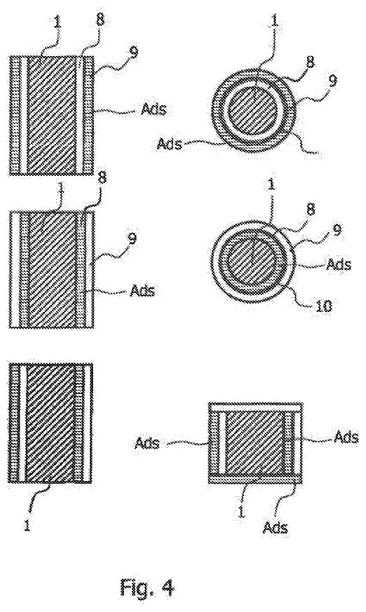

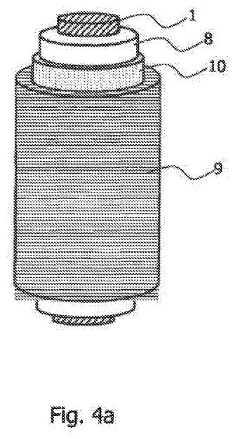

FIG. 4 a representation of a second embodiment of the battery arrangement with inner and outer flow channels,

FIG. 4a a perspective representation of the surrounding flow channels,

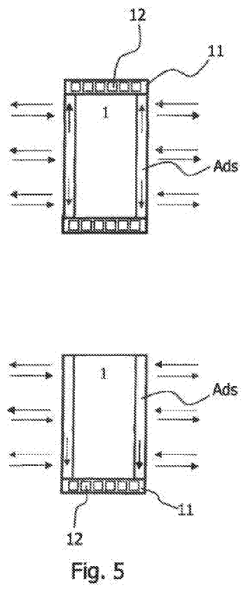

FIG. 5 a representation of a third embodiment of the battery arrangement with battery cells surrounded in sections,

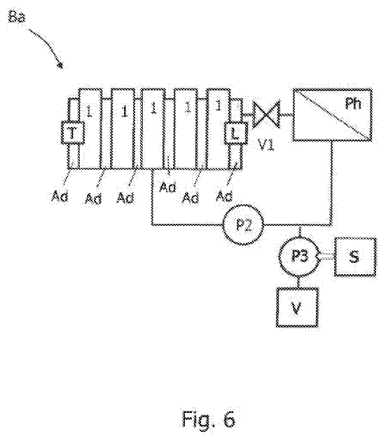

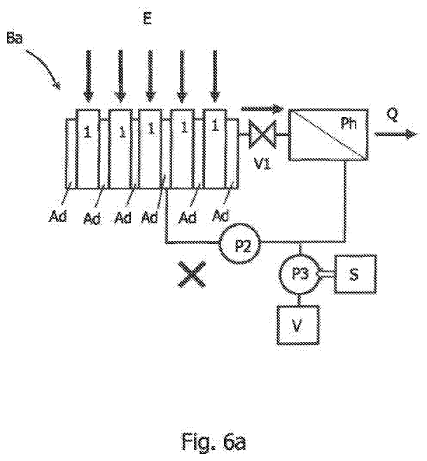

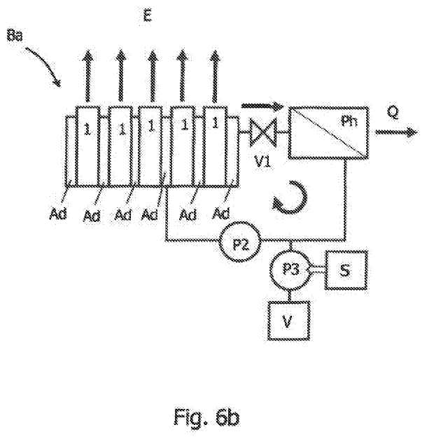

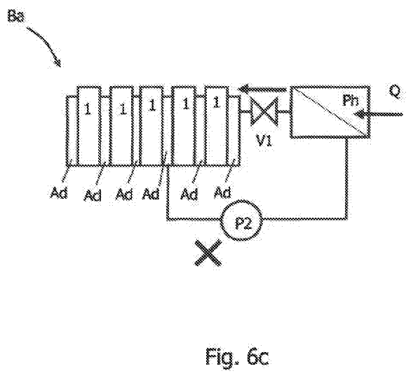

FIG. 6 a representation of the interconnection of the battery arrangement to components of the heat carrier circuit,

FIG. 6a a representation of the battery temperature control during a quick charging process,

FIG. 6b a representation of the battery temperature control during a continuous operation of the battery arrangement and an adsorber regeneration,

FIG. 6c a representation of the battery temperature control during pre-heating of the battery arrangement in the event of cold ambient temperatures,

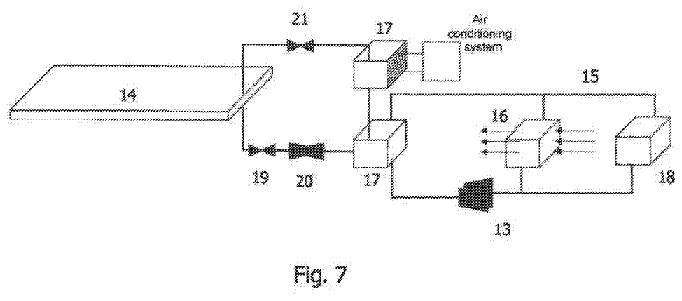

FIG. 7 a possible embodiment of a cooling circuit using a heat pipe,

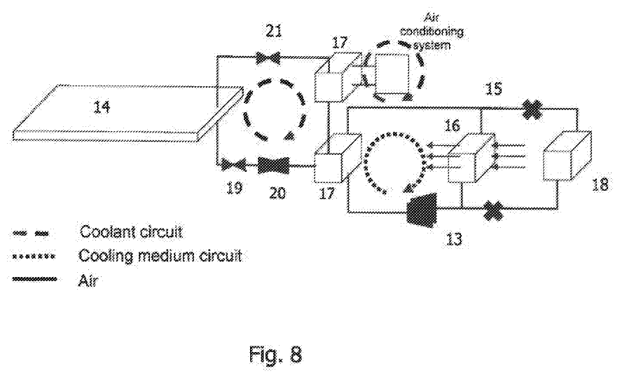

FIG. 8 a representation of the operational mode of the additional heat carrier circuit for constant cooling,

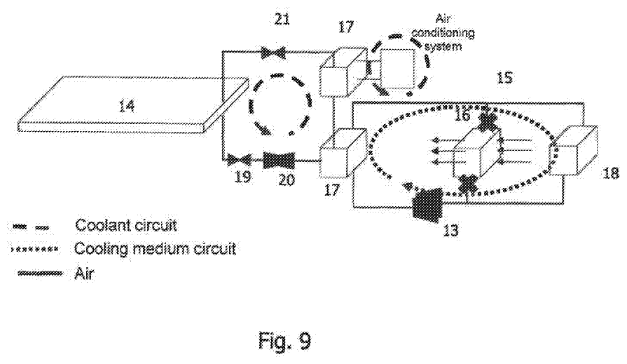

FIG. 9 an operational mode for heating the battery in the event of low ambient temperatures by means of an external heat supply,

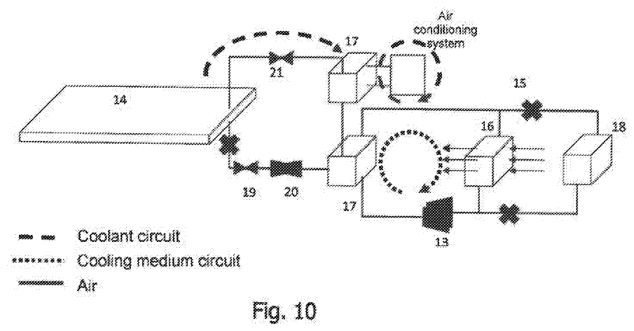

FIG. 10 a representation of the operational mode for charging the thermal storage system, in particular for cooling,

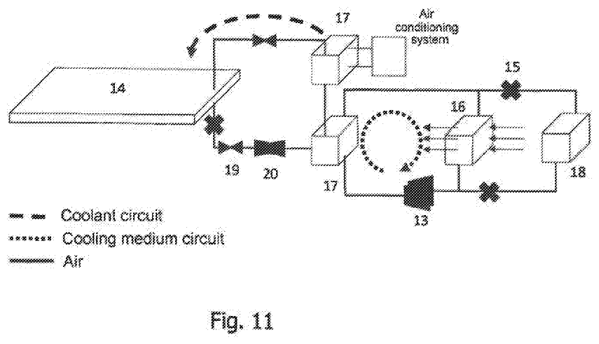

FIG. 11 a representation of the operational mode for discharging the thermal storage system, in particular for heating the battery,

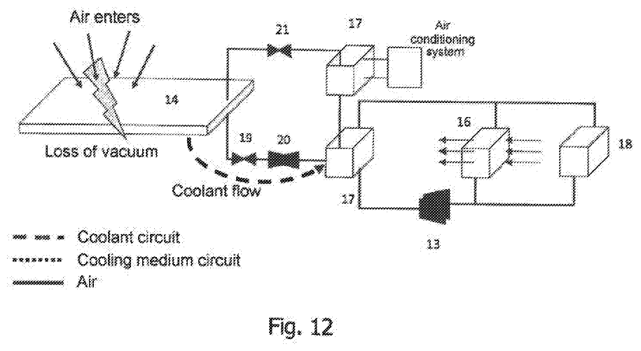

FIG. 12 a representation of the mode of action when air enters,

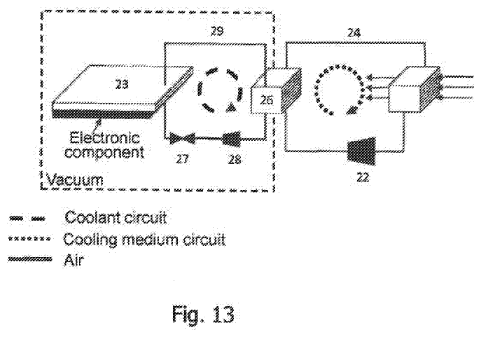

FIG. 13 an exemplary use of the heat pipe system for controlling the temperature of an electronic component.

FIG. 1a shows a principle representation of a battery temperature control with an adsorber and a phase converter according to the state of the art for reasons of comparison.

The arrangement of the battery temperature control according to the state of the art shown in FIG. 1a is basically based on an adsorption heat pump A. A battery arrangement Ba is in thermal contact with an adsorber Ad, in particular with an adsorbent Ads contained within the adsorber Ad. As a part of the adsorption heat pump A, the adsorber is in connection with a phase converter Ph. A working medium AM is circulated between the adsorber and the phase converter. The working medium is adsorbed or desorbed at the adsorbent Ads of the adsorber. A valve V1 controls the flow of the gaseous working medium between the adsorber and the phase converter.

During the adsorption of the working medium, adsorption heat is released. Hereby, heat is supplied to the battery arrangement Ba. But the battery may also give off heat to the adsorbent and hereby be cooled. When the battery gives off heat to the adsorbent Ads, the adsorbed working medium will be expelled from the adsorbent and will condense in the phase converter Ph.

By these processes, the battery is thus heated or cooled. The heat that the working medium gives off or takes up during these processes via the adsorbent, is exchanged via the phase converter with external components. In this case, the working medium normally is condensed or evaporated in the phase converter. The condensation of the working medium in the phase converter takes place when the working medium is expelled from the adsorbent and the battery arrangement Ba is thus cooled. The evaporation of the working medium takes place when the working medium is being adsorbed into the adsorbent and thus during heating of the battery.

The condensation heat released during the condensation of the working medium in the phase converter or the evaporation heat taken up in the phase converter during the evaporation of the working medium, for example, is exchanged with an air conditioning system K of the vehicle. In this case, a further medium flows within the air conditioning system of the vehicle, which medium takes up heat at the phase converter Ph or gives off heat to the latter. When heat is supplied to the phase converter, the working medium evaporates in the phase converter and is adsorbed into the adsorbent of the adsorber, wherein it gives off this heat to the battery. Basically, the air conditioning system K may also be replaced by any external system which is able to take up heat and thus serves as a heat sink, or which supplies heat and thus can be used as a heat source.

In the example present here, the air conditioning system K comprises a compressor C, valves V2 to V4, and various heat exchangers Hx1 and Hx2 for controlling the temperature of a passenger compartment and/or for the heat transfer to the environment.

The desorption of the adsorber Ad and thus cooling of the battery arrangement Ba takes place in particular during quick charging of the battery arrangement during which a large heat amount needs to be dissipated from the battery arrangement.

During the quick charging of the battery arrangement, the battery charging exhaust heat desorbs the saturated adsorber Ad. The released adsorptive flows to the phase converter Ph, where it condenses. The condensation heat is dissipated by the external system, in this case the air conditioning system K of the car. After the end of the desorption, valve V1 is closed within the adsorption heat pump A. The working medium is now condensed virtually completely in the phase converter, and the adsorbent Ads is unloaded.

The adsorption of the working medium in the adsorber is performed during a storage discharge of the battery when heating of the battery is necessary especially at low ambient temperatures. This takes place to be able to withdraw the full battery power which is only given in an optimum temperature range.

For heating the battery arrangement Ba, valve V1 is opened. The adsorber Ad aspirates the condensate of the working medium contained within the phase converter Ph. The working medium is adsorbed into the adsorbent Ads and releases heat during the adsorption. Via the thermal contact, in particular via heat conduction, the released heat reaches the battery arrangement Ba and is given off to its cells. The necessary evaporation heat is supplied to the phase converter Ph at ambient temperature via an external system, in the example present here, a heat exchanger of the air conditioning system K.

Such an arrangement, however, does not allow to guarantee the battery arrangement Ba to be cooled continuously by the adsorptive temperature control system. In such a system, the loading of the adsorbent in the adsorber with the working medium, i.e. the sorbate, is normally in inverse correlation to the charging state of the battery. This is due to the fact that the working medium is expelled from the adsorbent during quick charging of the battery for battery cooling. The working medium is then completely or at least to its major part in a condensed form within the phase converter and also remains wherein as long as the battery is not required to be heated. It is no longer available for further cooling the battery arrangement.

Moreover, returning the working medium into the adsorbate Ads is simply no longer possible. In particular in the case of high outdoor temperatures which do not require the battery to be heated in cold starting, a transfer of the working medium back into the adsorber would lead to the battery to be overheated. The system illustrated in FIG. 1a thus does not offer a possibility for the adsorption heat to be dissipated to the environment, and does moreover not allow the battery arrangement Ba to be cooled continuously during ongoing operation.

For this purpose, potential solutions will be indicated in the present exemplary embodiments.

FIG. 1b shows a principle representation of the additional heat carrier circuit as a complementation of the cyclical operation of the adsorption heat pump according to a first embodiment of the method according to the invention. The additional heat carrier circuit Z is assigned to the adsorption heat pump A. It extends over the entire arrangement of battery arrangement Ba and adsorber Ad and exchanges heat via a heat exchanger WÜ with external heat sources and/or heat sinks. These external heat sources and heat sinks, for example, are a passenger compartment, the environment or even an external heat pump. The heat carrier circuit is likewise in thermal contact with the phase converter Ph of the adsorption heat pump. The heat transferring fluid circulating within the additional heat carrier circuit is circulated by forced convection, i.e. via a pump P2.

The additional heat carrier circuit basically fulfills two functions. First, it enables the battery arrangement to be continuously temperature-controlled during regular operation, in particular to be cooled or heated continuously to a suitable operational temperature. Second, the additional heat carrier circuit enables the working medium to be retransferred from the phase converter Ph back into the adsorbent Ads or, optionally, the working medium to be shifted from the adsorbent Ads into the phase converter Ph, wherein the heat developing or to be taken up in this case may be easily dissipated or supplied via the additional heat carrier circuit, without the temperature control of the battery arrangement Ba being impaired. Finally, the additional heat carrier circuit thus enables the selective setting of a certain initial configuration of the adsorption heat pump.

The fluid circulated by forced convection within the additional heat carrier circuit may also be the working medium of the adsorption heat pump A itself and flow through the components of the adsorption heat pump directly and thus not only in thermal contact. In such a case, the working fluid is added in excess, and thus the components of the adsorption heat pump are flooded to such an extent that the working medium can neither make any phase transitions within the phase converter Ph nor any adsorption or desorption processes within the adsorbate Ads. In such a case, the working mediums flows through the additional heat carrier circuit by forced convection and, in doing so, functions as a mere heat-transferring fluid. The advantage of such a mode of operation is that all of the components of the adsorption heat pump can be loaded with the working medium via the additional heat carrier circuit, wherein the additional heat carrier circuit itself puts the adsorption heat pump into a defined initial state and in particular fills the adsorber with the working medium. In this case, the thereby developing adsorption heat is easily dissipated by the working medium circulating in excess, with the temperature control of the battery arrangement Ba to a required operational temperature being always guaranteed.

FIG. 1c shows an exemplary embodiment of an additional heat carrier circuit Z when using a heat pipe functionality, i.e. a so-called heat pipe. In this case, the heat carrier circuit Z constitutes in its entirety the heat pipe which is always characterized by a sub-circuit for the vapor transport and a sub-circuit for the liquid transport. In the exemplary embodiment shown here, the heat transferring fluid circulates through the phase converter Ph, where a phase transition from liquid to gaseous takes place. Via the valve V1, the developed vapor flows to the adsorber Ad where it condenses on the surface of the adsorbent Ads and thereby gives off the condensation heat to the adsorber and thus heats the battery. The transport of the condensed liquid is performed via the pump P2 back to the phase converter Ph.

For cooling the battery, the process is reversed and the heat carrier circuit Z passed through in the reversed direction: during the evaporation on the adsorber Ad, the adsorber and in conjunction with it the battery is cooled, the vapor flows to the phase converter via valve V1. On the phase converter, the vapor condenses and thereby heats the circuit K to the heat sinks mentioned above via the pump P1. The liquid in the circuit Z is conveyed back to the adsorber via the pump P2.

The heat transport in the heat pipe mode including a phase change thus enables the heat to be transferred very effectively via the phase change enthalpy between the battery arrangement Ba and the circuit K even without adsorption and desorption processes. It was revealed surprisingly that the structure according to the invention for transporting heat between the battery arrangement and the circuit K can be utilized both without (FIG. 1b) and with phase transition (FIG. 1c) and can simply be regulated via the system pressure and the pump controls. A realization without the pump P2 is also possible if the liquid transport via suitable mechanisms such as e.g. capillary forces is sufficient.

FIG. 1d shows a further example for an arrangement for controlling the temperature of a battery arrangement Ba on which the method according to the invention is based. The arrangement shown here contains all of the components according to the representation of FIG. 1a, i.e. in particular the battery arrangement Ba with the adsorber Ad brought in thermal contact and the adsorbent Ads, which adsorber again is an integral part of the adsorption heat pump A. Here again, the adsorption heat pump is coupled to the air conditioning system K of the vehicle as the external system by way of example.

In contrast to the arrangement according to FIG. 1a, apart from the circuit between the phase converter and the battery arrangement via V1, an additional heat transfer circuit Z is provided and joined in a heat transferring manner to the entire arrangement of battery arrangement Ba and adsorber Ad, which dissipates arising heat from this entire arrangement or supplies this entire arrangement with required heat, if necessary, and is built up separately from the circuit via the valve V1. The phase converter Ph of the adsorption heat pump in this exemplary embodiment is not an integral part of the additional heat transfer circuit Z. This means for the battery arrangement Ba that the heat amount required for controlling the temperature can be transferred to be distributed over two channels, and namely such that the battery unit is temperature-controlled virtually continuously in a uniform and graduated manner depending on the operational load via two devices structurally separated from one another.

For the exemplary embodiments in FIGS. 1b to 1d, this means in particular that the amount of the working medium present in the phase converter Ph can be returned into the adsorber Ad and be again adsorbed there without heating the battery excessively, since the adsorption heat being released there can be dissipated via the additional heat transfer circuit Z. This can in particular also take place at high ambient temperatures and a comparatively high charging state of the battery arrangement Ba, so that enough working medium will be present again within the adsorber Ad to significantly cool the battery, if necessary, even at high power consumptions. It is thus possible for the above-mentioned inverse correlation between the battery charging state and the distribution of the working medium within the adsorption heat pump to be cancelled and designed to be variable instead.

The heat that is to be supplied to or dissipated from the battery arrangement Ba can be dissipated or supplied from the auxiliary fluid circuit in very different ways. Possible are a heat transfer to the external heat source or heat sink already used by the adsorption heat pump A, here, for example, to the air conditioning system of the vehicle, or a direct heat transfer to the environment via the circuit Z.

The battery arrangement Ba and the adsorbent Ads arranged on it are correspondingly designed for a heat transfer to the additional heat carrier circuit. Hereinafter, some designs of the battery arrangement in conjunction with the adsorber will be explained by way of example.

The heat transfer at the battery cell takes place, for example, by heat conduction within the adsorber structure material, e.g. by aluminum sheets or open-pored structures (aluminum foams or fibers) to which the adsorbent is applied.

For this purpose, a heat conduction device 2 is provided in a first embodiment concerning the device. FIG. 2 shows here a corresponding example. If the battery arrangement Ba is composed of a plurality of battery cells as functional basic units, this heat conduction device is provided at each battery cell.

FIG. 2 shows a battery cell 1. This battery cell is surrounded by the adsorbent Ads and is in thermal contact with it. The adsorbent Ads forms an adsorbent section 3 on the battery cell surface. An envelope similar to a sleeve slid upon the battery or a flow channel filled with the adsorbent is possible. The working medium as the adsorbent is adsorbed into or desorbed from the adsorbent according to the cyclical mode of operation of the adsorption heat pump.

Furthermore, the device of FIG. 2 has a heat conducting section 4 in thermal contact both with the battery cell 1 and the adsorber section 3. The heat conducting section 4 may be formed as cooling plates. The cooling plates thus cause heat to be exchanged with the additional heat carrier circuit. They constitute an additional temperature control unit of the battery cell 1.

The cooling plates 4 are then loaded with the fluid, in particular a liquid, of the additional heat carrier circuit Z.

The heat carrier circuit Z formed as a liquid circuit cools the battery during the continuous operation when the battery heat is too high during operation. The liquid circuit can also provide cooling when excessive condensate needs to be adsorbed so that the next quick charging of the battery can be prepared. As described, the liquid circuit can either be circulated by means of a pump or be realized as a heat pipe in which the heat transfer takes place by phase conversion.

An embodiment of the battery arrangement Ba formed as a battery pack is advantageous, wherein the battery pack as a whole is coupled in both as a part of the fluid circuit and the adsorption heat pump.

The battery pack can be structured such that, on the one hand, each battery cell is in contact with a surface covered by the fluid from the additional heat carrier circuit Z, which acts in particular as cooling liquid, and, on the other hand, is in thermal contact with a surface covered by the material of the adsorbent Ads. The side which is covered by the adsorbent Ads provides cooling during the quick charging and guarantees the battery cells to be preheated at cold outdoor temperatures. The additional heat carrier circuit provides continuous cooling when the vehicle is in operation or when excessive condensate in the adsorbent needs to be adsorbed and the heat released in this case to be dissipated.

FIG. 3 shows an exemplary embodiment of such a battery pack 7 which forms the battery arrangement Ba in the example shown here. The battery pack is composed of a number of battery cells 1. Flow channels extend between the battery cells. These are alternatingly either sorption flow channels 5 filled with an adsorbent, or heat flow channels 6 through which the fluid flows. The sorption flow channels as a whole constitute des adsorber Ad of the adsorption heat pump. Accordingly, the battery pack in its entirety of battery cells and sorption flow channels is an integrated adsorber-battery unit, the heat dissipation and heat reception of which is regulated as a whole by the heat flow channels flowed through. This integrated arrangement allows the net heat balance from the adsorber and the battery arrangement as a whole to be regulated and monitored in a particularly effective manner.

The battery arrangement according to FIG. 4 can be structured such that the entire surface of each individual battery cell is in thermal contact with a cooling fluid from the additional heat carrier circuit Z, wherein this arrangement in turn as a whole is in contact with an adsorbent material. A solid thin layer of good heat conductivity, e.g. an aluminum foil, separates the area of the cooling fluid from the adsorbent volume.

The inverse construction is likewise possible: the battery cells are in contact with the adsorbent material, which in turn is in contact with a cooling fluid. A solid thin layer, e.g. aluminum foil, separates the area of the cooling fluid from the adsorbent volume.

This construction can be adapted to the form of the cells. In FIG. 4, a battery cell 1 in cylindrical form is shown to be surrounded by an inner flow channel 8. The inner flow channel 8 in turn is surrounded by an outer flow channel 9. These channels in turn are separated from one another by a partition 10 of good heat conductivity but are in thermal contact with one another. One of the two flow channels is in this case filled with the adsorbent Ads, and in this flow channel cyclical adsorptions and desorptions are performed, the other one is flowed through by the fluid of the fluid circuit and serves, for example, to dissipate excessive adsorption heat and to cool the battery cells during normal operation.

This arrangement may also be an arrangement laid out alternatingly at least in sections, as illustrated the lower example in FIG. 4.

FIG. 4a shows the arrangement in a perspective representation. The battery cell 1 and the flow channels 8 and 9 build a concentric and cylindrical structure. In this structure, a dynamic thermal equilibrium between the battery cell and the flow channels 8 and 9 can be realized within the entire arrangement. Ultimately, the battery cell 1 is temperature-controlled in that the flow channel 8 and the flow channel 9 in their properties as part of the adsorber or the fluid circuit mutually exchange heat, with the net heat flow resulting therefrom being fed from the battery cell 1 or dissipated into the battery cell.

FIG. 5 shows a structure of a battery cell 1 with a surrounding adsorbent Ads as part of the adsorber of the adsorption heat pump and heat carrier plates 11 on the front sides thereof in two variants. The heat carrier plates, for example, constitute cooling plates on the front sides and cool the entire arrangement of battery cell and adsorbent Ads according to requirements. The battery and the adsorber pack can also be structured such that the lateral surface of the battery cells is in contact with sorbent material, and the upper side and the lower side—or only the upper side or only the lower side—are in contact with the cooling liquid of the additional heat carrier circuit.

The heat dissipation during quick charging is mostly achieved by desorption of the adsorbent material. The heat dissipation in continuous operation or when excessive condensate is adsorbed is mostly achieved by heat transfer to the cooling liquid. The preheating of the battery is achieved by the adsorption of the working medium present as a condensate.

In their interior, the heat carrier plates 11 have flow channels 12 through which the fluid of the additional heat carrier circuit flows.

A further option to achieve flexibility of the temperature control of the battery arrangement by the system of the adsorption heat pump without requiring a second fluid system or a heat conduction structure is to combine the same system both for heat transfer by desorption and adsorption, i.e. in the storage operation, with the operation as an adsorption heat pump, and for heat transfer by circulating the cooling medium without any phase conversion in continuous operation.

For this purpose, after charging the battery and the desorption of the adsorbent caused by that, the adsorptive in liquid form is introduced in excess into the adsorber. The adsorber is thus flooded so that in the adsorbent, it is not the adsorption heat which is released by accumulation of the adsorptive from the vapor phase but the significantly lower latent heat from the liquid phase. This heat can be dissipated through the circuit of the liquid adsorptive. The adsorptive thus acts exclusively as a heat carrier medium.

Such a system enables both a fluid to be allowed to circulate within the adsorber and to regenerate a dry adsorber, i.e. to load it newly with working medium. Hereby, both a continuous cooling and a cooling during the quick charging are provided. By setting the system pressure in the additional heat carrier circuit by means of the secondary cooling circuit, the point may be selected in advance from which the heat transfer by forced convection transits into the heat transfer by desorption/condensation and is replaced. This may take place in case of high charging powers but also in the case of high discharging powers, i.e. at high acceleration of the vehicle.

Alternatively, it can be defined by supplying and discharging the liquid adsorptive by means of a pump, whether the system is in the mode of forced convection and thus of heat circulation or in the mode of desorption/condensation and thus is in the mode of the adsorption heat pump.

In the event of low outdoor temperatures requiring the battery to be heated by adsorption during driving operation or for the cold start, switching-over between continuous cooling and the adsorption/desorption operation, i.e. between the operation as a heat carrier circuit and the operation as an adsorption heat pump needs to be performed in due time. This mode must be activated by the vehicle management system at certain outdoor temperatures.

FIGS. 6, 6a to 6c show the respective operational states by means of exemplary block diagrams. Shown are according to FIG. 6 a number of battery cells 1 each surrounded by the adsorber unit Ad. Via a valve V1, the working medium may be circulated between the adsorber unit and the phase converter Ph. Moreover, a stock reservoir V for the working medium and a pump P3 are provided which pump can be switched on by a control unit S. Via a pump P2, a circuit between the adsorber Ad, the phase converter, and the pump P2 can be realized. A temperature sensor T and a charge sensor L register the temperature and the fluid charge of the adsorber unit and the battery cells and output these values to the control unit S.

FIG. 6a shows the circuitry of the temperature control device of the battery installation during a quick charging process (energy input E). The battery arrangement Ba is composed of individual battery cells 1 between which the adsorber unit Ad is arranged with the adsorbent. Via a valve V1, the adsorber is connected to a phase converter Ph. Moreover, a pump P2 is provided. These aforementioned members are situated in a branch leading from the phase converter back to the adsorber Ad. The branch leading via the pump P2 is activated when the arrangement functions as a heat carrier circuit.

In a quick charging process of the battery, the valve V1 will be opened. The pump P2, however, is inactive. The working medium is desorbed from the adsorber Ad by the heat emission of the battery cells 1 and gets into the phase converter Ph where it condenses and outputs the heat Q as described above into the environment or external components.

After completion of the quick charging process, the working medium is in the phase converter Ph as a condensate. The battery arrangement is electrically charged and ready for operation. It permanently gives off heat during the continuous vehicle operation and thus during the discharging and needs to be cooled for maintaining an optimum operational temperature.

As represented in FIG. 6b, the phase converter is now loaded in excess with working medium from a working medium reservoir V. The pump P2 drives the working medium added in excess into the adsorber Ad within the battery arrangement. During this, a loading of the adsorber by force takes place, wherein only a slight adsorption of the working medium into the adsorbent is performed. The adsorption does not take place to a higher extent because it is prevented by the heat emission of the battery arrangement. The working medium, however, flows through the adsorber and during this, picks up the heat generated by the battery arrangement. The working medium thus acts as a cooling medium for the battery arrangement, with the circulation proceeding—when the valve V1 is opened and under the influence of pump P2—serving as a cooling circuit of the battery arrangement. During this, the working medium gets again into the phase converter Ph and may be collected there and, if necessary, be discharged.

After completion of the battery operation, the cooling circuit is operated such that as little liquid working medium as possible remains within the adsorber. The working medium added in excess is discharged out from the phase converter and back into a reservoir. The cooling circuit is thus ready to preheat the battery arrangement anew.

The preheating of the battery arrangement at low temperatures is illustrated in FIG. 6c. The adsorber Ad is practically free from working medium. The phase converter Ph contains a stock of liquid working medium. Now, the valve V1 is opened. The liquid working medium evaporates and is adsorbed at the adsorbent of the adsorber Ad. The adsorption heat released in this case is dissipated to the battery and heats the battery.

The adsorbent consists in particular of highly capillary materials such as zeolites. The working medium diffuses into the part coated with the adsorbent. In the desorption of the working medium, this part plays the role of an evaporative cooler during battery cooling. In the adsorption of the working medium, this part acts as a heater for heating the battery.

A further possible structure of the system is represented in FIG. 7.

In the following FIGS. 7 to 13 means: 13 cooling medium pump, 14 battery including adsorber, 15 cooling medium piping, 16 cooler, 17 phase converter, 18 heater, 19 condensate valve and line, 20 condensate pump, 21 steam valve and line. The steam valve 21 is only required for heat storage in the adsorptive operation.

FIG. 8 represents a mode of operation of a continuous battery cooling via the additional heat carrier circuit. This mode of operation is performed as follows:

The working medium serving as a system coolant of the adsorption heat pump, for example, water, is pumped by means of the condensate pump 20 from the phase converters 17 through the condensate line and the condensate valve 19 into the adsorber volume of the battery including the adsorber 14.

When the cooling medium enters the adsorber volume, it will propagate through the sorbent material due to capillary action. In this way, the sorbent material becomes wet, and the heat generated by the electrical losses within the battery cells evaporates the liquid coolant. The pressure within the adsorber volume is therefore close to the evaporation pressure of the coolant at the desired battery temperature.

Once it is in steam form, the cooling medium back naturally to the phase converters 17, where it condenses again into the liquid form. This condensation takes place due to the active cooling of the components of the phase converter, which is achieved either via an ambient temperature cooler circuit 16 or via a coupling of the vehicle heat pump (or a compressor-based air conditioning system). It is of importance here that this process is forced by the condensate pump 20 and is not driven by adsorptions and desorptions.

Consequently, the adsorbent material merely plays the role of a heat distributor in this mode of operation. This process takes place continuously as long as exhaust heat from the battery is present to promote the evaporation of the cooling medium, with the condensed cooling medium being pumped back into the adsorber.

FIG. 9 represents the mode of operation of a continuous heating of the battery. The system can be used on cold days for heating the battery due to external heat supply. In this mode, the system works as follows:

Heat from an external heat pump of the vehicle or an external heater 18 is supplied to the phase converter 17. The heat enables the cooling medium condensate present within the phase converters 17 to be evaporated. The evaporated cooling medium flows naturally to the adsorber volume of the battery and the adsorber 14, where it condenses at a contact with the cold surface. The surface heats during the reception of the condensation heat. This heat is then transferred to the battery by heat conduction.

The condensed coolant flows to the bottom of the adsorber volume by gravity and, due to the condensate pump 20 is pumped back to the phase converters via the condensate line. Here as well, it should be emphasized that this process is performed by forced convection and is driven by means of the condensate pump.

This cycle may be continued until the desired battery temperature is reached.

A further mode of operation is focused on heat storage. In FIG. 10, a steam valve 21 is represented on the steam line of the system. This valve is present when a thermal energy storage is to be used with the system. The heat storage capacity depends on the amount of sorption material contained in the adsorber.

In the heat storage mode, the system works as described hereinafter:

The charging of the storage system in conjunction with a cooling process is represented in FIG. 10. The condensate line is closed by means of the condensate valve 19. The electrical exhaust heat of the battery is used during quick charging and other modes of operation to desorb the humid adsorbent in the arrangement comprised of battery and adsorber 14. The released coolant steam from this desorption flows to the phase converters where it condenses. This condensation takes place by active cooling of the phase converter via external circuitries such as the vehicle heat pump or the compressor-based air conditioning system or the ambient temperature cooling circuit. Once the desired coolant amount has been desorbed from the adsorbent material, or once the adsorbent material is dry, the steam line valve 21 can be closed for isolating the adsorber completely from the phase converters 17.

The discharging of the storage system in conjunction with a heating process of the battery arrangement is represented in FIG. 11. Before the heat energy is given off to the adsorber, the adsorber is cold and both the condensate and the steam lines are in closed states, i.e. the adsorber 14 and the phase converters 17 are completely isolated from each other. The release of the heat energy takes place when the steam line is opened. The opening of the valve 21 reduces the pressure within the phase converter, and the coolant condensate starts to evaporate, flows to the adsorber and is adsorbed by the adsorbent material. The adsorption of the coolant releases heat energy which is transferred to the battery via conduction. On the other side, the occurring evaporation cools the phase converters. In order that this process lasts as long as necessary or as long as the system is not completely discharged, the evaporation heat needs to be supplied to the phase converters. This evaporation heat may be supplied via the cooler circuit at ambient temperature so as to keep the temperature of the phase converters stable.

An advantage of the heat management system described above is that it is very safe. The coolant, for example water, may be a safe end environmentally friendly substance. The major part of the coolant present within the adsorber volume is in the form of steam, which coolant, in the case of water, being non-conductive and having better dielectric strength than air. Only small amounts of the liquid coolant can accumulate at the bottom of the adsorber. As shown in FIG. 12, in the event of the system failing, the liquid volume would automatically leave the adsorber due to the increased system pressure. Consequently, the system is intrinsically safe, and the adsorbent material can be arranged in proximity to the battery cells without impairing the vehicle safety.

The heat pipe system described herein may be extended to applications in which small electronic components for highly dense and spatially confined cooling requirements are cooled. The heat conduction through the material having a layer of sorption material may indeed be higher than 10 kW/m²K, which represents a great improvement as compared to a cooling system on the basis of cooling medium circulation.

Electronic components can release great heat amounts per surface unit. This heat pipe system enables this heat to be distributed to a much greater surface, the phase converters, in which external circuits can be used conventionally to dissipate the heat to the environment. This is represented in FIG. 13. In FIG. 13 means: 22 cooling medium pump, 23 cooled chip including adsorber, 24 cooling medium piping, 25 cooler, 26 phase converter, 27 condensate valve and line, 28 condensate pump, 29 steam line.

The main advantages of a heat pipe system based on adsorption are extremely high heat conduction, uniform heat dissipation and supply, continuous operation both in cooling and heating, and a possibility of storing heat for low consumption of electricity.

### LIST OF REFERENCE NUMERALS

A adsorption heat pump

Ad adsorber

Ads adsorbent

Ba battery arrangement

E electric battery charging or discharging

F fluid circuit

HP heat pipe

K air conditioning system

P1-P3 pumps

Ph phase converter

V1 valve

Q heat

WÜ heat exchanger

Z additional heat carrier circuit

1 battery cell

2 heat conduction device

3 adsorbent section

4 heat conducting section

5 sorption flow channel

6 heat flow channel

7 battery pack

8 inner flow channel

9 outer flow channel

10 partition, heat-conducting

11 heat carrier plate

12 flow channel

13 cooling medium pump

14 battery including adsorber

15 cooling medium piping

16 cooler

17 phase converter

18 heater

19 condensate valve and line

20 condensate pump

21 steam valve and line

22 cooling medium pump

23 cooled chip including adsorber

24 cooling medium piping

25 cooler

26 phase converter

27 condensate valve and line

28 condensate pump

29 steam line

1. A method for controlling the temperature of a battery arrangement (Ba) made up of at least one battery cell (1) by means of a cyclically operated adsorption heat pump (A), consisting of an adsorber (Ad) and a phase converter (Ph), with a working medium (AM) circulated between the adsorber and the phase converter,
wherein the at least one battery cell (1) is brought into thermal contact with an adsorbent (Ads) of the adsorber (Ad) and the temperature of the battery cell (1) is controlled in that the battery arrangement picks up adsorption heat and gives off desorption heat,
wherein the heat released in the phase converter during a condensation process of the working medium and the heat picked up during an evaporation process of the working medium is dissipated to the environment and supplied from the latter,
characterized in that
the battery arrangement (Ba) and the adsorber (Ad) are, if necessary, brought into thermal contact, via an auxiliary fluid circuit (Z), with a heat transferring fluid circulated in the auxiliary fluid circuit,
wherein the heat transferring fluid is brought into thermal contact with external heat sources and/or heat sinks, wherein the battery arrangement is supplied, if necessary, with thermal energy from external heat sources via the auxiliary fluid circuit or thermal energy is withdrawn from the battery arrangement via the auxiliary fluid circuit and is dissipated to external heat sinks.

2. The method according to claim 1,
characterized in that
the auxiliary fluid circuit is materially separated from the adsorption heat pump, wherein the heat transferring fluid is guided via a heat exchange surface along the entire arrangement comprised of the battery arrangement (Ba) and the adsorber (ad).

3. The method according to claim 1,
characterized in that
during the start-up of the auxiliary fluid circuit, the adsorption heat pump (A) is temporarily shifted from cyclical operation to an operating mode of forced convection, wherein the working medium is introduced in excess into the adsorber, and the adsorber is flooded, wherein the liquid working medium (AM) is subsequently circulated as the heat transferring fluid by forced convection without any phase change.

4. The method according to claim 2,
characterized in that
the switch-over between cyclical operation and operation of forced convection is performed by a controlled change of the system pressure within the adsorption heat pump (A), wherein the change of the system pressure is performed depending on instantaneous operating parameters and/or operational states of the battery arrangement (Ba), in particular of charging and/or discharging powers of the battery arrangement (Ba) and/or depending on current environmental conditions.

5. The method according to claim 2,
characterized in that
the switch-over between cyclical operation and operation of forced convection is performed by supplying and discharging the working medium by means of a pump unit (P3), wherein the control of the pump unit is performed depending on instantaneous operating parameters of the battery arrangement (Ba) and/or current environmental conditions.

6. The method according to claim 1,
characterized in that
the auxiliary fluid circuit (Z) is formed as a heat pipe (W), wherein the heat transferring fluid performs phase transitions.

7. A temperature-controlled battery arrangement (Ba) composed of a plurality of battery cells (1) and a battery cell temperature control unit integrated in the battery arrangement and surrounding each individual battery cell, wherein the battery cell temperature control unit may be coupled to external temperature control devices.

8. The temperature-controlled battery arrangement (Ba) according to claim 7,
characterized in that
the battery cell temperature control unit has an adsorbent section (3) covering at least one first surface section of the battery cell and being in thermal contact with the battery cell for coupling to an adsorption heat pump, and a second, heat conducting section (4) in thermal contact with a heat transferring fluid circulating in an auxiliary fluid circuit.

9. The temperature-controlled battery arrangement (Ba) according to claim 7,
characterized in that
the battery cell temperature control unit is comprised of a series of flow channels extending between the battery cells (1), wherein the flow channels are formed alternatingly as sorption flow channels (5) filled with an adsorbent and loaded with an adsorbate, and as heat flow channels (6) through which a heat transferring fluid can flow.

10. The temperature-controlled battery arrangement according to claim 7,
characterized in that
the battery cell temperature control unit is formed as an arrangement of a first, inner flow channel (8) surrounding the battery cell (1) in thermal contact and a second, outer flow channel (9) surrounding the inner flow channel in thermal contact.

11. The temperature-controlled battery arrangement according to claim 10,
characterized in that
the inner or the outer flow channel (8 or 9) is filled with an adsorbent, and the adsorbent can be loaded with an adsorbate, wherein the flow channel filled with the adsorbent is coupled to an adsorption heat pump, and the respective other flow channel is coupled to an external heat carrier circuit.

12. The temperature-controlled battery arrangement according to claim 7,
characterized in that
the battery cell temperature control unit is formed in the form of heat transfer plates (11) through which a fluid flows and which are in thermal contact with a first surface section of the battery cell (1) and a sorption channel loaded with an adsorbent (Ads), wherein the heat transfer plates are connected to an external heat carrier circuit, and the sorption channel is part of an adsorption heat pump.
